(19) United States
(12) Patent Application Publication
(10) Pub. No.: US 2023/0023216 A1
(43) Pub. Date: Jan. 26, 2023

(54) BATTERY CELL AND BATTERY CONTAINING SUCH BATTERY CELL

(71) Applicant: NINGDE AMPEREX TECHNOLOGY LIMITED, Ningde City (CN)

(72) Inventors: Xuecheng LI, Ningde City (CN); Junhui HOU, Ningde City (CN)

(21) Appl. No.: 17/958,119

(22) Filed: Sep. 30, 2022

Related U.S. Application Data
(63) Continuation of application No. PCT/CN2020/082115, filed on Mar. 30, 2020.

(51) Int. Cl. H01M 50/198; H01M 50/105; H01M 10/058; H01M 50/533

(52) U.S. Cl. CPC H01M 50/198; H01M 50/105; H01M 10/058; H01M 50/533

(57) ABSTRACT

A battery cell includes an electrode assembly and a packaging bag for accommodating the electrode assembly, where the battery cell further includes a first adhesive layer and a second adhesive layer, and the first adhesive layer is adhered to a side of the electrode assembly; and the second adhesive layer is disposed on an outermost surface of the electrode assembly to bond the packaging bag and the electrode assembly, and the first adhesive layer is disposed between the electrode assembly and the second adhesive layer. A battery is further provided, including a housing and the foregoing battery cell, where the battery cell is accommodated in the housing.

### CROSS-REFERENCE TO RELATED APPLICATIONS

This application is a continuation of PCT application PCT/CN2020/082115, entitled “CELL AND BATTERY HAVING CELL” filed on Mar. 30, 2020, which is hereby incorporated by reference in its entirety.

This application is related to U.S. patent application Ser. No. 17/956,687, entitled “BATTERY CELL AND BATTERY CONTAINING SUCH BATTERY CELL” filed on Sep. 29, 2022, which is hereby incorporated by reference in its entirety.

### TECHNICAL FIELD

This application relates to the battery field, and in particular, to a battery cell and a battery containing such battery cell.

### BACKGROUND

At present, most commercially available electronic devices are powered by their built-in batteries. Now, battery cells in the marketplace all use packaging bags to accommodate electrode assemblies, and then are put into housings to form batteries for use. Falling is inevitable during use of an electronic device. During a fall, there may be relative movement between an electrode assembly and a packaging bag, resulting in a shear force between them to cause the electrode assembly to separate from the packaging bag, which in turn causes safety problems such as top seal being pushed open and battery being short-circuited, and eventually leads to battery failure.

### SUMMARY

In view of the foregoing issues, it is necessary to provide a battery cell and a battery containing such battery cell to reduce failure caused by falling.

An embodiment of this application provides a battery cell, including an electrode assembly and a packaging bag for accommodating the electrode assembly, where the battery cell further includes a first adhesive layer and a second adhesive layer, the first adhesive layer is adhered to a side of the electrode assembly, the second adhesive layer is disposed on an outermost surface of the electrode assembly to bond the packaging bag and the electrode assembly, and the first adhesive layer is disposed between the electrode assembly and the second adhesive layer.

According to some embodiments of this application, the outermost surface of the electrode assembly includes a first surface, a first cambered surface, a second surface opposite the first surface, and a second cambered surface opposite the first cambered surface that are joined in sequence, where the first adhesive layer is adhered to the first cambered surface or the second cambered surface, and the second adhesive layer is separately disposed on the first surface, the first cambered surface, the second surface, and the second cambered surface.

According to some embodiments of this application, the electrode assembly further includes an end surface opposite a tab of the electrode assembly, and the battery cell further includes a third adhesive layer, where one end of the third adhesive layer is adhered to the first surface, and the other end of the third adhesive layer is adhered to the second surface after bypassing the end surface.

According to some embodiments of this application, the first cambered surface and the second cambered surface are both provided with the first adhesive layer, and total width of the two first adhesive layers ranges from 20 mm to 40 mm.

According to some embodiments of this application, width of the first adhesive layer disposed on the first cambered surface or the second cambered surface ranges from 10 mm to 20 mm.

According to some embodiments of this application, the first adhesive layer is a single-sided adhesive, and the second adhesive layer is a double-sided adhesive.

According to some embodiments of this application, a length difference between the electrode assembly and the first adhesive layer ranges from 4 mm to 10 mm.

According to some embodiments of this application, a length difference between the first adhesive layer and the second adhesive layer ranges from 4 mm to 10 mm.

According to some embodiments of this application, a length difference between the electrode assembly and the second adhesive layer ranges from 10 mm to 20 mm.

An embodiment of this application further provides a battery, including a housing and the foregoing battery cell, where the battery cell is accommodated in the housing.

In the foregoing battery cell and the battery containing such battery cell, the first adhesive layer is adhered to a side of the electrode assembly, and the second adhesive layer is bonded to the outermost surface of the electrode assembly, to finally transfer a shear force caused by the packaging bag on the electrode assembly during falling to the first adhesive layer and the packaging bag. This helps address the problem that the electrode assembly separates from the packaging bag during falling of the battery cell, and further resolves the resulting safety failures such as top seal being pushed open and short circuit.

### BRIEF DESCRIPTION OF DRAWINGS

FIG. 1 is a main view of an electrode assembly according to an embodiment of this application.

FIG. 2 is a rear view of the electrode assembly shown in FIG. 1.

FIG. 3 is a cross-sectional view of a battery cell according to an embodiment of this application.

### REFERENCE SIGNS OF MAIN COMPONENTS

| | |
|---|---|
| Battery cell | 100 |
| Electrode assembly | 10 |
| Electrode assembly body | 11 |
| First surface | 111 |
| First cambered surface | 112 |
| Second surface | 113 |
| Second cambered surface | 114 |
| End surface | 115 |
| Tab | 12 |
| Positive tab | 121 |
| Negative tab | 122 |
| Packaging bag | 20 |
| First adhesive layer | 30 |
| Second adhesive layer | 40 |
| Third adhesive layer | 50 |

### DETAILED DESCRIPTION

The following clearly and describes the technical solutions in the embodiments of this application with reference to the accompanying drawings in the embodiments of this application. Apparently, the described embodiments are only some rather than all of the embodiments of this application. All other examples obtained by a person of ordinary skill in the art based on the examples of this application without creative efforts shall fall within the protection scope of this application.

It should be noted that when a component is referred to as being “fastened to” another component, it may be directly fastened to the another component, or there may be a component in between. When a component is deemed as being “connected to” another component, it may be directly connected to the another component, or there may be a component in between. When a component is deemed as being “provided on” another component, it may be directly provided on the another component, or there may be a component in between. The terms “vertical”, “horizontal”, “left”, “right”, and other similar expressions as used herein are for illustration only.

Unless otherwise defined, all technical and scientific terms used herein shall have the same meanings as commonly understood by those skilled in the art to which this application belongs. The terms used herein in the specification of this application are merely intended to describe specific embodiments but not intended to limit this application. The term “and/or” used herein includes any and all combinations of one or more related listed items.

This application provides a battery cell, including an electrode assembly and a packaging bag for accommodating the electrode assembly, where the battery cell further includes a first adhesive layer, adhered to a side of the electrode assembly, and a second adhesive layer, disposed on an outermost surface of the electrode assembly to bond the packaging bag and the electrode assembly, where the first adhesive layer is disposed between the electrode assembly and the second adhesive layer.

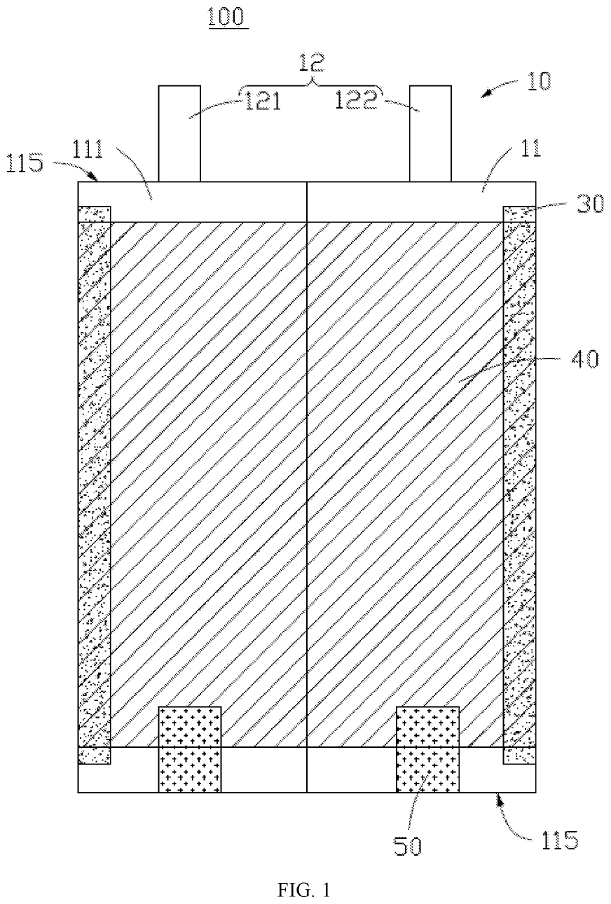

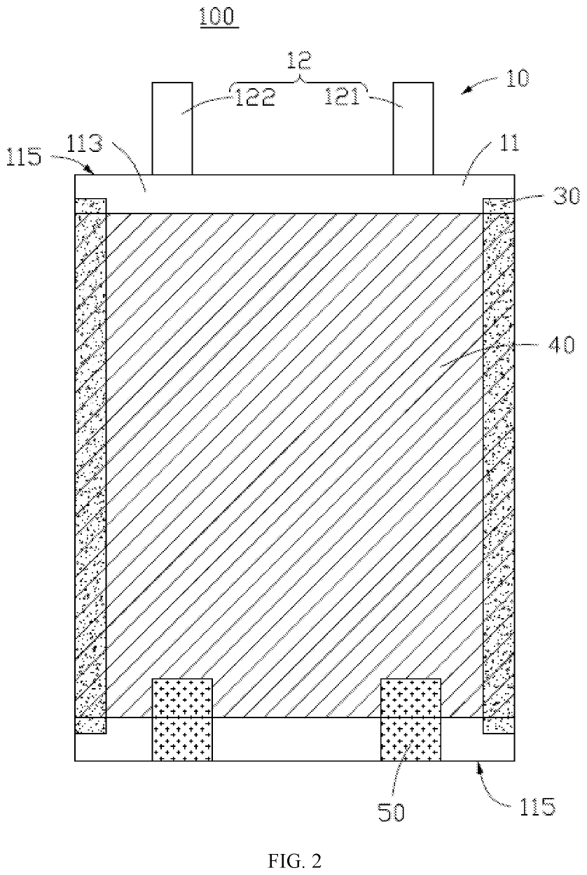

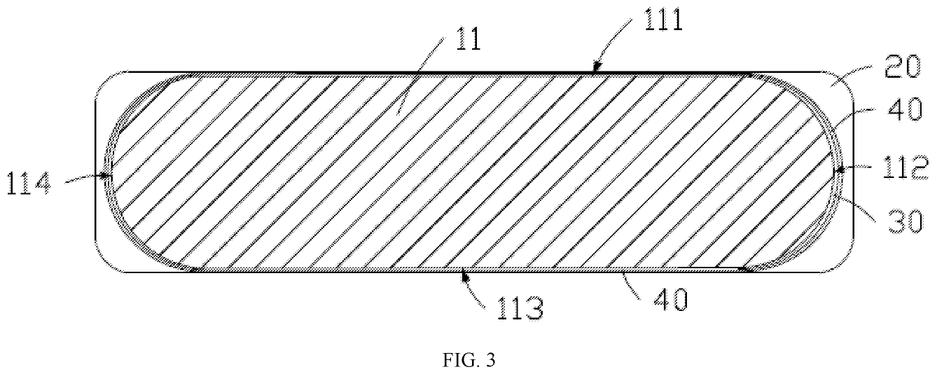

Referring to FIG. 1 to FIG. 3, an embodiment of this application provides a battery cell 100. The battery cell 100 includes an electrode assembly 10, a packaging bag 20, a first adhesive layer 30, and a second adhesive layer 40. The electrode assembly 10 is accommodated in the packaging bag 20. The first adhesive layer 30 is adhered to a side of the electrode assembly 10. One side of the second adhesive layer 40 is adhered to an outermost surface of the electrode assembly 10, and the other side is bonded to the packaging bag 20 so as to adhere the electrode assembly 10 to the packaging bag 20.

Specifically, the electrode assembly 10 includes an electrode assembly body 11 and tabs 12 disposed on the electrode assembly body 11.

The outermost surface of the electrode assembly body 11 includes a first surface 111, a first cambered surface 112, a second surface 113 opposite the first surface 111, and a second cambered surface 114 opposite the first cambered surface 112 that are joined in sequence. The electrode assembly body 11 further includes two end surfaces 115. The two end surfaces 115 are opposite each other and are separately connected to the first surface 111, the first cambered surface 112, the second surface 113, and the second cambered surface 114. The tabs 12 are disposed on one of the end surfaces 115.

In some embodiments, the outermost surface of the electrode assembly body 11 is made of aluminum foil. To be specific, the electrode assembly body 11 formed by winding is ended with aluminum foil.

In some embodiments, the tabs 12 include a positive tab 121 and a negative tab 122, the positive tab 121 may be made of aluminum, and the negative tab 122 may be made of nickel.

In some embodiments, the first adhesive layer 30 is provided in a quantity of two. The two first adhesive layers 30 are separately adhered to the first cambered surface 112 and the second cambered surface 114.

In some embodiments, the first adhesive layer 30 is adhered to a center in a length direction of the first cambered surface 112 and the second cambered surface 114 on sides of the electrode assembly body 11.

In some embodiments, the first adhesive layer 30 is a single-sided adhesive.

In some embodiments, the first adhesive layer 30 may use a polymer material as a matrix, because the polymer material has strong extensibility and the single-sided adhesive used can protect the aluminum foil, to further effectively prevent the aluminum foil from being torn out.

The first adhesive layer 30 cannot be excessively wide. The excessively wide first adhesive layer 30 may be excessively bonded on the first surface 111 or the second surface 113. The first adhesive layer 30 cannot be excessively narrow. The excessively narrow first adhesive layer 30 is insufficient to fully bond the first cambered surface 112 or the second cambered surface 114, resulting in that the second adhesive layer 40 is bonded to the electrode assembly body 11 on the first cambered surface 112 or the second cambered surface 114.

In some embodiments, a total width of the first adhesive layer 30 disposed on the first cambered surface 112 and the second cambered surface 114 ranges from 20 mm to 40 mm.

In some embodiments, width of the first adhesive layer 30 disposed on the first cambered surface 112 or the second cambered surface 114 ranges from 10 mm to 20 mm.

Preferably, the total width of the first adhesive layers 30 is 30 mm. For example, the width of the first adhesive layer 30 disposed on the first cambered surface 112 may be equal to that disposed on the second cambered surface 114, for example, both are 15 mm.

The first adhesive layer 30 cannot be excessively long. The excessively long first adhesive layer 30 may be bonded to an end surface 115 of the electrode assembly body 11 and extend into a sealing area of the tabs. The first adhesive layer 30 cannot be excessively short. The excessively short first adhesive layer 30 is insufficient to fully bond the first cambered surface 112 or the second cambered surface 114, resulting in that the second adhesive layer 40 is directly bonded to the electrode assembly body 11 on the first cambered surface 112 or the second cambered surface 114.

In some embodiments, a length difference between the electrode assembly body 11 and the first adhesive layer 30 ranges from 4 mm to 10 mm.

Preferably, the length difference between the electrode assembly body 11 and the first adhesive layer 30 is 7 mm.

The second adhesive layer 40 is disposed around the outermost surface of the electrode assembly body 11. To be specific, the second adhesive layer 40 is separately disposed on the first surface 111, the first cambered surface 112, the second surface 113, and the second cambered surface 114. The first adhesive layer 30 is disposed between the first cambered surface 112 or the second cambered surface 114 of the electrode assembly body 11 and the second adhesive layer 40.

In some embodiments, the second adhesive layer 40 is bonded to the middle of the electrode assembly body 11 in a length direction. In some embodiments, the second adhesive layer 40 is a double-sided adhesive.

The first adhesive layer 30 fills gaps between corners of the electrode assembly body 11 (the first cambered surface 112 or the second cambered surface 114 ) and the packaging bag 20, such that the second adhesive layer 40 has no transition interface between an adhesive surface and a non-adhesive surface and a shear force on the transition interface is transferred to the first adhesive layer 30, thereby increasing bonding strength of the second adhesive layer 40.

In some embodiments, the second adhesive layer 40 is bonded to the outermost surface of the electrode assembly body 11 by coating.

The packaging bag 20 is bonded to an outer side of the second adhesive layer 40 to accommodate the electrode assembly 10.

The second adhesive layer 40 cannot be excessively long. The excessively long second adhesive layer 40 may be directly bonded to a surface of the electrode assembly body 11 on the first cambered surface 112 or the second cambered surface 114. The second adhesive layer 40 cannot be excessively short. The excessive short second adhesive layer 40 is unable to provide sufficient bonding force to tightly bond the electrode assembly 10 and the packaging bag 20, resulting in tears.

In some embodiments, a length difference between the first adhesive layer 30 and the second adhesive layer 40 ranges from 4 mm to 10 mm.

In some embodiments, a length difference between the electrode assembly body 11 and the second adhesive layer 40 ranges from 10 mm to 20 mm.

Preferably, a length difference between the first adhesive layer 30 and the second adhesive layer 40 is 7 mm. A length difference between the electrode assembly body 11 and the second adhesive layer 40 is 14 mm.

In some embodiments, the battery cell 100 further includes a third adhesive layer 50. One end of the third adhesive layer 50 is adhered to the first surface 111, and the other end of the third adhesive layer 50 is adhered to the second surface 113 after bypassing the end surface 115 opposite an end surface 115 provided with the tabs 12. The third adhesive layer 50 provided around the bottom can cooperate with the second adhesive layer 40 to bond the packaging bag 20 to the electrode assembly 10, and can also better protect the electrode assembly 10.

In some embodiments, the third adhesive layer 50 is disposed between the first surface 111 or the second surface 113 of the electrode assembly body 11 and the second adhesive layer 40.

In some embodiments, the third adhesive layer 50 is provided in two or other quantities.

In some embodiments, the third adhesive layer 50 is a single-sided adhesive.

An embodiment of this application further provides a battery, including a housing and the foregoing battery cell 100, where the battery cell 100 is accommodated in the housing.

Drop tests are performed on batteries obtained according to this application and on conventional batteries not using the design in this application.

Examples: An electrode assembly 10 with a length of 90 mm was packaged, a third adhesive layer 50 with a width of 12 mm and a length of 25 mm was used at the bottom for applying adhesive, and a first adhesive layer 30 with a width of 15 mm and a length of 80 mm was used at sides of a first cambered surface 112 and a second cambered surface 114 for applying adhesive. A second adhesive layer 40 with a length of 70 mm was applied on the outermost surface of the electrode assembly 10, and then the electrode assembly 10 was packaged in the packaging bag 20.

Comparative examples: An electrode assembly 10 with a length of 90 mm was packaged, a third adhesive layer 50 with a width of 12 mm and a length of 25 mm was used at the bottom for applying adhesive, a second adhesive layer 40 with a length of 70 mm was applied on the outermost surface of the electrode assembly 10, and then the electrode assembly 10 was packaged in a packaging bag 20.

Batteries in 10 examples and batteries in 10 comparative examples were separately subjected to drop tests at a height of 1.8 m. Test results: All the batteries in the examples were not torn out, while all the batteries in the comparative examples were torn out.

In the battery cell 100 and the battery containing the battery cell 100, the first adhesive layer 30 is adhered to each side of the electrode assembly 10 to fill the gap between the side of the electrode assembly 10 and the packaging bag 20, and then the second adhesive layer 40 is bonded to the outermost surface of the electrode assembly 10, to finally transfer the shear force caused by the packaging bag 20 on the electrode assembly 10 to the first adhesive layer 30 and the packaging bag 20 during falling. This helps address the problem that the electrode assembly 10 separates from the packaging bag 20 during falling of the battery cell 100, and further resolves the resulting safety failures such as top seal being pushed open and short circuit.

The foregoing embodiments are merely intended to describe the technical solutions of this application, but not intended to constitute any limitation. Although this application is described in detail with reference to the foregoing preferred embodiments, persons of ordinary skill in the art should understand that modifications or equivalent replacements can be made to the technical solutions of this application, without departing from the spirit and scope of the technical solutions of this application.

What is claimed is:

1. A battery cell, comprising an electrode assembly and a packaging bag for accommodating the electrode assembly; wherein the battery cell further comprises:
a first adhesive layer adhered to a side of the electrode assembly; and
a second adhesive layer disposed on an outermost surface of the electrode assembly to bond the packaging bag and the electrode assembly, wherein the first adhesive layer is disposed between the electrode assembly and the second adhesive layer.

2. The battery cell according to claim 1, wherein the outermost surface of the electrode assembly comprises a first surface, a first cambered surface, a second surface opposite the first surface, and a second cambered surface opposite the first cambered surface that are joined sequentially, wherein the first adhesive layer is adhered to the first cambered surface or the second cambered surface; and the second adhesive layer is separately disposed on the first surface, the first cambered surface, the second surface, and the second cambered surface.

3. The battery cell according to claim 2, wherein the electrode assembly further comprises an end surface opposite a tab of the electrode assembly, and the battery cell further comprises a third adhesive layer, wherein one end of the third adhesive layer is adhered to the first surface, and the other end of the third adhesive layer is adhered to the second surface after bypassing the end surfaces.

4. The battery cell according to claim 2, wherein the first cambered surface and the second cambered surface are both provided with the first adhesive layer, and a total width of the two first adhesive layers ranges from 20 mm to 40 mm.

5. The battery cell according to claim 4, wherein a width of the first adhesive layer disposed on the first cambered surface or the second cambered surface ranges from 10 mm to 20 mm.

6. The battery cell according to claim 1, wherein the first adhesive layer is a single-sided adhesive, and the second adhesive layer is a double-sided adhesive.

7. The battery cell according to claim 1, wherein a difference between a length of the electrode assembly and a length of the first adhesive layer ranges from 4 mm to 10 mm.

8. The battery cell according to claim 1, wherein a difference between a length of the first adhesive layer and a length of the second adhesive layer ranges from 4 mm to 10 mm.

9. The battery cell according to claim 1, wherein a difference between a length of the electrode assembly and a length of the second adhesive layer ranges from 10 mm to 20 mm.

10. A battery, comprising a housing and the battery cell according to claim 1, wherein the battery cell is accommodated in the housing.

11. A battery, comprising a housing and the battery cell according to claim 2, wherein the battery cell is accommodated in the housing.

12. A battery, comprising a housing and the battery cell according to claim 3, wherein the battery cell is accommodated in the housing.

13. A battery, comprising a housing and the battery cell according to claim 4, wherein the battery cell is accommodated in the housing.

14. A battery, comprising a housing and the battery cell according to claim 5, wherein the battery cell is accommodated in the housing.

15. A battery, comprising a housing and the battery cell according to claim 6, wherein the battery cell is accommodated in the housing.

16. A battery, comprising a housing and the battery cell according to claim 7, wherein the battery cell is accommodated in the housing.

17. A battery, comprising a housing and the battery cell according to claim 8, wherein the battery cell is accommodated in the housing.

18. A battery, comprising a housing and the battery cell according to claim 9, wherein the battery cell is accommodated in the housing.
